(19) United States
(12) Patent Application Publication
(10) Pub. No.: US 2017/0111368 A1
(43) Pub. Date: Apr. 20, 2017

(54) SYSTEMS AND METHODS FOR TRUE PRIVILEGE APPLICATION ELEVATION

(71) Applicant: BeyondTrust Software, Inc., Phoenix, AZ (US)

(72) Inventors: Brad Hibbert, Carp (CA); Gyle Iverson, Phoenix, AZ (US); Julie Lustig-Rusch, Phoenix, AZ (US); James Mitchell, Phoenix, AZ (US); Jeffery Nielsen, Phoenix, AZ (US)

(21) Appl. No.: 15/390,596

(22) Filed: Dec. 26, 2016

Related U.S. Application Data
(63) Continuation-in-part of application No. 14/983,418, filed on Dec. 29, 2015, now Pat. No. 9,531,726.
Application No. 14/983,418 is a continuation of application No. 14/327,087, filed on Jul. 9, 2014, now Pat. No. 9,225,723.
Application No. 14/327,087 is a continuation of application No. 12/571,231, filed on Sep. 30, 2009, now Pat. No. 8,863,253.
Application No. 12/571,231 is a continuation-in-part of application No. 12/497,429, filed on Jul. 2, 2009, now Pat. No. 9,160,545.
(60) Provisional application No. 62/274,066, filed on Dec. 31, 2015.
(60) Provisional application No. 61/219,359, filed on Jun. 22, 2009.

(51) Int. Cl. H04L 29/06

(52) U.S. Cl. CPC H04L 63/105; H04L 63/068; H04L 63/08

(57) ABSTRACT

A method comprising storing a privilege rule, detecting an instruction to execute an application, and determining whether execution of the application requires an elevated privilege. The example method further comprises identifying, responsive to a determination the execution of the application requires the elevated privilege, one or more attributes of the application, and generating a request for the elevated privilege based on the privilege rule and the one or more attributes of the application. The method further comprises receiving the elevated privilege responsive to an approval of the request for the elevated privilege, and causing the execution of the application with the elevated privilege.

### CROSS-REFERENCE TO RELATED APPLICATIONS

This U.S. Non-Provisional patent application claims the benefit of U.S. Provisional Patent Application No. 62/274,066, filed Dec. 31, 2015, entitled “Systems and Methods for True Privilege Application Elevation”, the contents of which are expressly incorporated herein by this reference as though set forth in their entirety. The present application is also a continuation-in-part of U.S. patent application Ser. No. 14/983,418, filed Dec. 29, 2015, entitled “Systems and Methods for Automatic Discovery of Systems and Accounts,” now U.S. Pat. No. 9,531,726, which is a continuation of U.S. patent application Ser. No. 14/327,087, filed Jul. 9, 2014, entitled “Systems and Methods for Automatic Discovery of Systems and Accounts,” now U.S. Pat. No. 9,225,723, which is a continuation of U.S. patent application Ser. No. 12/571,231, filed Sep. 30, 2009, entitled “Systems and Methods for Automatic Discovery of Systems and Accounts,” now U.S. Pat. No. 8,863,253, which is a continuation-in-part of U.S. patent application Ser. No. 12/497,429, filed Jul. 2, 2009, entitled “Systems and Methods for A2A and A2DB Security Using Program Authentication Factors,” now U.S. Pat. No. 9,160,545, which claims priority to U.S. Provisional Patent Application Ser. No. 61/219,359, filed Jun. 22, 2009, entitled “Systems and Methods for A2A and A2DB Security Using Program Authentication Factors,” which are all hereby incorporated herein this by reference as though set forth in their entirety and priority to which is claimed.

### FIELD OF USE

Various embodiments discussed herein relate generally to elevating privileges for application execution. More particularly, various embodiments relate to systems and methods that utilize an agent to facilitate execution of applications with true elevated privileges.

### BACKGROUND

All too often, too many users of a network are granted full, unrestricted superuser, root, or administrator privileges, regardless of whether or not access is needed. Even if unrestricted access is needed occasionally, many users maintain full, unrestricted access persistently. This “all trusting” environment is insecure to both inside and outside attacks. Further, this type of approach is frequently coupled with a lack of accountability of this access. These privileged accounts are often exploited by unethical insiders and hackers to perpetrate fraud, steal data, and/or damage systems.

A similar issue exists with non-human processes in the area of application-to-application (A2A) or application-to-database (A2DB) communication involving service accounts on various IT systems. The passwords for these accounts are often hard-coded or embedded in the calling application or script and rarely, if ever, change. Couple this with the fact that any skilled administrator or programmer with access to the application source code or script may view those passwords, and the potential for damage greatly increases.

Due to the depth of access that privileged and embedded passwords provide to highly sensitive and confidential information, and the fact that these access credentials are shared among administrators, it is only natural that security experts and compliance auditors are recommending and requiring more scrutiny and control in this area. Without a system of checks and balances and overall accountability for privileged and embedded passwords, an organization is open to exploitation and exposes mission-critical systems to intentional or accidental harm and malicious activity.

Therefore what is needed is needed is a computer-implemented method for storing a privilege rule, detecting an instruction to execute an application, and determining whether execution of the application requires an elevated privilege.

### SUMMARY

To minimize the limitations in the prior art, and to minimize other limitations that will become apparent upon reading and understanding the present specification, the following discloses a new and useful computer-implemented method for storing a privilege rule, detecting an instruction to execute an application, and determining whether execution of the application requires an elevated privilege.

The systems and methods described herein may provide enhanced security and/or improved user workflow for application privilege elevation. Typical systems may elevate application privileges using application security tokens. However, elevating application security tokens may be unsuccessful for applications that need to communicate across a network because security tokens may only be recognized locally. Other typical systems may have a user check out and/or manually enter account credentials (e.g., username and password) for an administrator account (or, super-user account), however such systems may have inherent security flaws (e.g., revealing administrator credentials) and/or may interrupt user workflow. The systems and methods described herein address these, and other, problems.

In various implementations, security agents executing on client devices facilitate execution of applications with true elevated privileges retrieved from a security system. True elevated privileges may include, for example, account credentials associated with an account with elevated privileges, such as an administrator account. Client devices may include, for example, mobile devices, laptops, smartphones, desktops, hardened devices, servers, and/or so forth. In some embodiments, applications may be transparently executed with true elevated privileges retrieved from a security system without displaying, or otherwise revealing, the true elevated privileges and/or requiring input from a user. For example, applications may be executed automatically with the “RUN AS” command using the retrieved true elevated privileges.

Furthermore, the systems and methods described herein may allow application elevation on an application-by-application basis without potentially granting elevated privileges for other applications. Moreover, application execution with true elevated privileges as described herein may be automated such that applications appear to be executed with the user's own credentials. For example, a particular application (e.g., regedit) may require a higher privilege-level than the user's associated privilege-level. A security agent may initiate execution of the particular application with true elevated privileges retrieved from a security system without prompting the user to enter a new set of credentials, and/or potentially compromising security by exposing administrator credentials to the user.

One embodiment is a method for true privilege application elevation, the steps comprising: providing a client device; storing, by the client device, at least one privilege rule; detecting, by the client device, an instruction to execute an application; determining, by the client device, whether execution of the application requires an elevated privilege; generating, by the client device, a request for the elevated privilege based on the at least one privilege rule; communicating the request for the elevated privilege to a security system that is in operative communication with the client device; receiving, by the client device, a privilege response from the security system; wherein the privilege response is a response selected from the group of responses selected from: an approval and a denial; wherein if the privilege response is an approval, then the application is executed with the elevated privilege. Wherein if the privilege response is an approval the privilege response may comprise one or more true elevated privileges. The method may further comprise: identifying, responsive to determining the execution of the application requires the elevated privilege, one or more attributes of the application; wherein the request for the elevated privilege may further be based on the one or more attributes of the application. The client device may comprise a security agent; wherein the security agent may comprise an agent management module, and/or an agent rules database that may store the at least one privilege rule. The at least one privilege rule may be generated by the agent management module or may be retrieved from the security system. The security agent may further comprise an agent communication module that may receive the privilege response and an agent authentication module that may authenticate a source of the privilege response. The security agent may further comprise an agent encrypt/decrypt module that may decrypt the privilege response. The agent encrypt/decrypt module may encrypt the request for the elevated privilege and the agent communication module may communicate the request for the elevated privilege to the security system.

Another embodiment is a method for true privilege application elevation, the steps comprising: providing a client device; storing, by the client device, at least one privilege rule; detecting, by the client device, an instruction to execute a first application; determining, by the client device, whether execution of a second application on a remote device requires an elevated privilege, the second application linked to the first application via the network connection; generating, by the client device, a request for the elevated privilege for the second application based on the at least one privilege rule; communicating the request for the elevated privilege to the security system that is linked to the client device via a network connection; receiving, by the client device, a privilege response from the security system; wherein the privilege response is a response selected from the group of responses selected from: an approval and a denial; wherein if the privilege response is an approval, then the second application is executed with the elevated privilege. Wherein if the privilege response is an approval the privilege response may comprise one or more true elevated privileges. The method may further comprise: identifying, responsive to determining that execution of the second application requires the elevated privilege, one or more attributes of the second application; wherein the request for the elevated privilege may further be based on the one or more attributes of the second application. Preferably, the client device may comprise a security agent, wherein the security agent may comprise: (a) an agent management module; (b) an agent rules database that may store the at least one privilege rule; (c) an agent communication module that (i) may receive the privilege response and (ii) may communicate the request for the elevated privilege to the security system; and (d) an agent authentication module that may authenticate a source of the privilege response; and (e) an agent encrypt/decrypt module that may decrypt the privilege response and that may encrypt the request for the elevated privilege. The at least one privilege rule may be generated by the agent management module or may be retrieved from the security system.

In another embodiment, the method may comprise the steps: providing security system; generating and storing, by the security system, one or more device records; generating and storing, by the security system, one or more security system privilege rules; receiving a request for an elevated privilege, by the security system; determining, by the security system, whether to approve or deny the request for the elevated privilege; generating, by the security system a privilege response; wherein the privilege response is a response selected from the group of responses selected from: an approval and a denial; communicating, by the security system, the privilege response to a client device; wherein if the privilege response is an approval, then an application is executed with the elevated privilege. Wherein the security system may approve or deny the request for the elevated privilege based on the one or more security system privilege rules. The security system may approve or deny the request for the elevated privilege based on one or more attributes of the application. The security system may comprise: (a) a security system management module; (b) a security system rules database that may store the one or more security system privilege rules; (c) a security system communication module that (i) may receive the request for the elevated privilege and (ii) may communicate the response to the request for the elevated privilege to the client device; (d) a security system authentication module that may authenticate a source of the request for the elevated privilege; and (e) a security system encrypt/decrypt module that decrypts the request for the elevated privilege and that encrypts the response to the request for the elevated privilege. The one or more security system privilege rules may be generated by the security system management module. Preferably, when the privilege response is an approval, the privilege response may comprise one or more true elevated privileges. The security system may further comprise a security system privilege module that may retrieve the one or more true elevated privileges.

It is an object of the new method to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of an example system and environment for executing applications with true elevated privileges according to some embodiments.

FIG. 2 is a block diagram of one embodiment of a client device comprising a security agent according to some embodiments.

FIG. 3 is a block diagram of one embodiment of a client device comprising an example security agent according to some embodiments.

FIG. 4 is a block diagram of one embodiment of a security system according to some embodiments.

FIG. 5 is a flow block diagram of one embodiment of a method of operation for an example security agent according to some embodiments.

FIG. 6 is a flow block diagram of one embodiment of a method of operation for an example security agent according to some embodiments.

FIG. 7 a flow block diagram of one embodiment of a method of operation for an example security system according to some embodiments.

FIG. 8 is a block diagram of one embodiment of a digital device according to some embodiments.

### DETAILED DESCRIPTION OF THE ILLUSTRATIVE EMBODIMENTS

In the following detailed description of various embodiments, numerous specific details are set forth in order to provide a thorough understanding of various aspects of one or more embodiments. However, these embodiments may be practiced without some or all of these specific details. In other instances, well-known methods, procedures, and/or components have not been described in detail so as not to unnecessarily obscure aspects of embodiments of the invention.

While multiple embodiments are disclosed, other embodiments will become apparent to those skilled in the art from the following detailed description, which shows and describes illustrative embodiments. As will be realized, the invention is capable of modifications in various obvious aspects, all without departing from the spirit and scope of protection. Accordingly, the graphs, figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of the following embodiments. For example, as used herein, the terms “computer” and “computer system” generally refer to any device that processes information with an integrated circuit chip.

As used herein, the terms “software” and “application” refer to any set of machine-readable instructions on a machine, web interface, and/or computer system” that directs a computer's processor to perform specific steps, processes, or operations disclosed herein. The application or software may comprise one or more modules that direct the operation of the computer system on how to perform the disclosed method.

As used herein, the term “computer-readable” medium may refer to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

The systems and methods described herein may provide enhanced security and/or improved user workflow for application privilege elevation. Typical systems may elevate application privileges using application security tokens. However, elevating application security tokens may be unsuccessful for applications that need to communicate across a network because security tokens may only be recognized locally. Other typical systems may have a user check out and/or manually enter account credentials (e.g., username and password) for an administrator account (or, super-user account), however such systems may have inherent security flaws, e.g., revealing administrator credentials, and/or may interrupt user workflow. The systems and methods described herein address these, and other, problems.

In various implementations, security agents executing on client devices facilitate execution of applications with true elevated privileges retrieved from a security system. True elevated privileges may include, for example, account credentials associated with an account with elevated privileges, such as an administrator account. Client devices may include, for example, mobile devices, laptops, smartphones, desktops, hardened devices, servers, and/or so forth. In some embodiments, applications may be transparently executed with true elevated privileges retrieved from a security system without displaying, or otherwise revealing, the true elevated privileges and/or requiring input from a user. For example, applications may be executed automatically with the “RUN AS” command using the retrieved true elevated privileges.

Furthermore, the systems and methods described herein may allow application elevation on an application-by-application basis without potentially granting elevated privileges for other applications. Moreover, application execution with true elevated privileges as described herein may be automated such that applications appear to be executed with the user's own credentials. For example, a particular application (e.g., regedit) may require a higher privilege-level than the user's associated privilege-level. A security agent may initiate execution of the particular application with true elevated privileges retrieved from a security system without prompting the user to enter a new set of credentials, and/or potentially compromising security by exposing administrator credentials to the user.

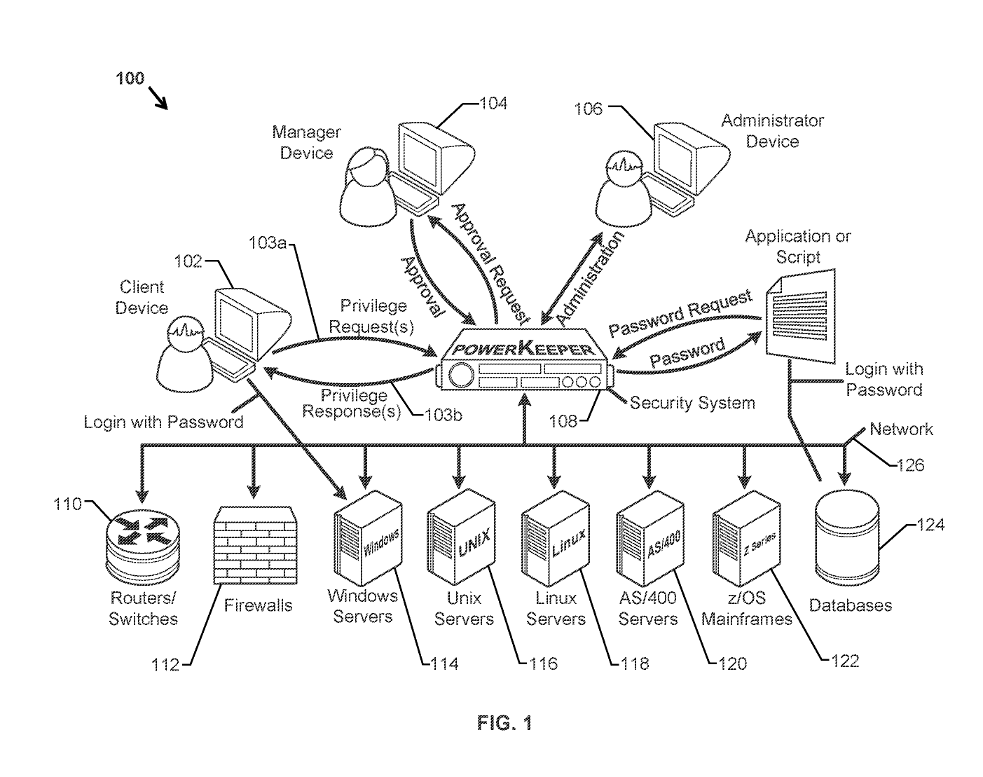

FIG. 1 is an illustration of one embodiment of an example system and environment for executing applications with true elevated privileges according to some embodiments. FIG. 1 illustrates an example system and environment 100 for executing applications with true elevated privileges according to some embodiments. The system and environment 100 includes a client device 102 (or “user device”), a manager device 104, and an administrator device 106, each of which may each communicate with a security system 108. Routers/switches 110, firewalls 112, windows servers 114, Unix servers 116, Linux servers 118, AS/400 servers 120, z/OS mainframes 122, and databases 124 may each be operatively coupled to a network 126 which may be operatively coupled to the security system 108.

In various embodiments, a digital device may comprise the client device 102, the manager device 104, the administrator device 106, the security system 108, routers/switches 110, firewalls 112, the windows servers 114, the Unix® servers 116, the Linux® servers 118, the AS/400 servers 120, the z/OS mainframes 122, and/or the databases 124. It will be appreciated that a digital device is any device with a processor and memory, such as a computer. Digital devices are further described herein.

The client device 102 is any digital device with one or more accounts (e.g., user accounts, service accounts, and the like) and a security agent to facilitate executing applications with true elevated privileges. In some embodiments, true elevated privileges may include account credentials (e.g., username and password) associated with an account with elevated privileges, such as an administrator account. The client device 102 may be a mobile device, laptop, smartphone, desktop, hardened device, server, and/or so forth.

In some embodiments, the client device 102 is any digital device with an application that may seek access to a secured application and/or secured database. In one example, the user of the client device 102 may be an accountant and the seeking application may be Microsoft Access. The accountant may wish to access a secured accounting database on a network (e.g., stored within the databases 124). Before the seeking application gains access to the secured accounting database, a request to access the database (e.g., a registration request) may be approved. Once approved, the client device 102 may receive a password to be stored within the client device 102. Alternately, the password is not stored within the client device 102 but rather the client device 102 may receive the password when the seeking application requests access to the secured application. In some embodiments, the password may be associated with an expiration event after which the password is expired and the client device 102 must then request another password. The process of registering and seeking passwords is further described herein.

It will be appreciated that, in some embodiments, the secured database may be on the client device 102 and the seeking application on another device that is on the network 126. Similar to the example above, before the seeking application gains access to the secured database on the client device 102, the client device 102 may be accessible over the network 126 and a request to access the database (e.g., a registration request) may be approved by the security system 108. Once approved by the security system 108, assuming the client device 102 is accessible, the seeking application (or the digital device of the seeking application) may receive a password to access the secured database.

A seeking application is any application that requires a password or other authentication information before accessing a secure application and/or secured database. A secured application is any application that requires a password or other authentication information before being able to access the secured application. Similarly, a secured database is any database that requires a password or other authentication information before access is granted. It will be appreciated that a secured database may refer to any secured data structure and is not limited only to databases (e.g., a secured table).

The client device 102 may further include a security agent. The client device 102 is further discussed herein.

The manager device 104 is any digital device that may approve a registration request. In some embodiments, the client device 102 may provide a registration request. The registration request may include information about the user of the client device 102 (e.g., login information), the client device 102, itself, and/or a seeking application. The manager and/or an application on the manager device 104 may review the registration request and approve or deny the request. In one example, the manager device 104 is operated by a manager that may approve a registration request from the client device 102. In another example, the manager device 104 may be configured to automatically approve one or more registration requests. In some embodiments, the manager of the manager device 104 may approve one or more components of the registration request (e.g., program factors discussed herein) and the manager device 104 is configured to approve the same or different components of the registration request.

In another example, the manager may receive the registration request that indicates the user and the seeking application. If the user is authorized for access (e.g., the user is an accountant seeking access for financial information) and the seeking program is confirmed based on program factors, the manager may approve the registration request, thereby allowing the seeking application access. It will be appreciated that there may be any number of ways a manager and a managing device 104 may, either in combination or separately, review and examine registration requests for approval or denial. Further, it will be appreciated that the manager device 104 may be optional and the approval process may take place within the security system 108 (further described herein) and/or the administrator device 106.

The administrator device 106 is any digital device that configures the security system 108. In various embodiments, the administrator device 106 is operated by an administrator (e.g., a network administrator, security officer, or IT professional) who can configure the security system 108. In one example, the administrator device 106 may display a configuration interface (e.g., a web page from the security system 108) that allows configuration. The administrator device 106 may configure the security system 108 to perform different tasks depending upon the seeking application, the user of the client device 102, and/or the client device 102. In one example, the administrator device 106 may specify specific manager devices 104 which must approve a registration request from a specific user name before the registration request may be approved and access to a secured application provided (e.g., via a password). The administrator device 106 may also specify program factors that must be confirmed as well as what the values of the program factors are expected to be. It will be appreciated that the security system 108 may be configured in any number of ways.

The security system 108 may comprise hardware, software, or a combination of both. In various embodiments, a digital device includes the security system 108. The digital device may be cabled to (or otherwise in communication with) the network 126. In some embodiments, the security system 108 may comprise software configured to be run (i.e., executed) by a server, router, or other device. The security system 108 may also comprise hardware. For example, the security system 108 may comprise a Windows® 2003 server (such as a hardened Windows® 2003 server), with quad-core CPUs, hot swap mirrored drives, redundant power supplies, and redundant fans. The security system 108 may also comprise redundant CPUs and hot-bank memory.

In various embodiments, the security system 108 is configured (e.g., by an administrator and/or the administrator device 106) to provide security for accounts, applications and databases. In some examples, the security system 108 may be configured to process requests for true elevated privileges, generate and update account passwords, process registration requests, log relevant information, and so forth. In some embodiments, the security system 108 is configured to privilege requests 103a, approve or deny the request 103a, and/or transmit privilege responses 103b to the client device 102. For example, the privilege response 103b may include true elevated privilege credentials for approved requests 103a.

In various embodiments the security system 108 is configured to generate and update passwords for a secure application and/or secured application. In one example, software to create a password for a specific secured database (e.g., a secured SQL database) may be stored within or by the security system 108. The security system 108 may then execute the software. The software may comprise executable instructions which are executable by a processor to perform a method for creating or changing a password for one or more secured applications and/or secured databases. The security system 108 may interact directly (or indirectly) with one or more digital devices, secured applications, and/or secured databases to create or change the password. Once the password is generated, the security system 108 may store the password.

The security system 108 may also update the password to the secured application and/or the secured database. In various embodiments, the security system 108 determines an expiration event after which a password is expired (e.g., after a predetermined time or date). At that time, the security system 108 may change the password to the secured application and/or the secured database. In one example, the security system 108 interacts with the secured application and/or the secured database to change the password and then the security system 108 may store the password. The predetermined time or date may be any time or date. For example, the security system 108 may change a password of a secured application or database after a period of time (e.g., every day, hour, minute, or the like). The security system 108, for example, may change any number of passwords every thirty seconds while changing other passwords every week. It will be appreciated that any period of time may be used. Similarly, the security system 108 may change any number of passwords at a scheduled time and/or day.

It will be appreciated that the security system 108 may encrypt generated password(s) and/or encrypt storage where the password(s) is stored. The security system 108 may encrypt communications between the security system 108 and any other digital device (e.g., all communication between the client device 102 and the security system 108 may be encrypted). For example, the security system 108 may perform FIPS-140 validated encryption of data and communications, access control mechanisms, secure storage of credentials, and/or secure audit trails. The security system 108 may also comprise a sealed operating system.

The security system 108 may also process registration requests. In one example, prior to a seeking application on a client device 102 being allowed to access a secured application or secure database, the security system 108 may require registration. The client device 102 may then provide a registration request to the security system 108. The registration request may include information regarding the user, the client device 102, and/or the seeking application. Based on a prior configuration, the security system 108 may, based on the user, the client device 102, and/or the seeking application, review the registration request and/or route the registration request to one or more manager devices 104 for approval. In one example, the security system 108 may be configured to determine if the client device 102 and/or the user logged into the client device 102 have rights to the secured application and/or secured database. If the client device 102 and/or the user do not have rights, the security system 108 may be configured to deny the registration request. The security system 108 may also be configured to email or otherwise contact one or more manager devices 104 to receive approval for the registration request. For example, the administrator may configure the security system 108 to email all registration requests associated with a particular seeking application to a predetermined number of managers and/or manager devices 104. In some embodiments, the security system 108 may not approve the registration request until all managers and/or manager devices approve the registration.

The security system 108 may be configured to log all privilege requests, privilege elevation, registration requests, passwords, password changes, and/or password requests thereby creating a record of the activities of each user, client device 102, and/or seeking application. In some embodiments, the logs of the security system 108 may be used to confirm that the secured application and/or the secured database are being used as approved. The logs may also be encrypted. In various embodiments, the logs may be audited (e.g., by the administrator and/or the administrator device 106). The security system 108 may also be configured to provide reports regarding user/approver, requester activities, password maintenance, user and file entitlement (rights) and/or internal diagnostics. In a few examples, the reports may be exportable in CSV and HTML formats.

Although FIG. 1 shows curved lines between the client device 102 and the security system 108, the manager device 104 and the security system 108, as well as the administrator device 106 and the security system 108, it will be appreciated that the client device 102, manager device 104, and administrator device 106 may not be each directly connected to the security system 108. In one example, the client device 102, manager device 104, and administrator device 106 may be in communication with the security system 108 over one or more networks. The curved lines in FIG. 1 may depict the nature of the communication between a digital device and the security system 108. In one example, in order to receive a password to log into the windows servers 114, the client device 102 may send a password request to the security system 108. The security system 108 may be configured by the administrator device 106 (e.g., as depicted in FIG. 1 as “administration”) to send the password request to the manager device 104 for approval. The manager device 104 may send the approval to the security system 108 which may then provide the password to the client device 102. The password may then be provided to the Windows servers 114. In some embodiments, the password is not visible or displayed to the user of the client device 102.

In another example, the client device 102 may comprise a seeking application or script that seeks access to a secured database. Prior to access, the client device 102 (e.g., via the seeking application or script) may provide the password request to the security system 108 which may either provide the password or provide the password after the proper approvals have been obtained. The password may then be sent to the client device 102 which may log into the secured database to obtain access with the password.

It will be appreciated that the security system may not be limited to privilege elevation and/or password management. Although various embodiments described herein refer to elevating privileges, generating, changing, and providing passwords to access the secured application and/or the secured database, similar systems and methods may be used with any form of security, including the issuance of encryption keys (e.g., private or public keys), certificates, digital signatures, decryption keys, credentials as well as rights management to files, volumes, and/or devices. Instead of a password being provided to the client device 102, the security system 108 may alter user rights such that the user may view, access, make changes to, and/or share the secured application and or secured database. In some embodiments, the security system 108 may provide a password to the client device 102 as well as make changes to file rights. The security system 108 may provide access in any number of ways.

In some embodiments, the client device 102 may be required to provide a registration request for rights to a program or database on another digital device. The rights may include, but are not limited to, rights to view, access, make changes, and share with other users. The security system 108 may perform similar tasks as when a password is requested. In one example, the security system 108 may examine the registration request and analyze program factors to ensure that the seeking application, user, or client device 102 is authorized and/or authenticated. One or more manager devices 104 may also approve the registration request. Upon approval, the security system 108 may grant any number of rights to access the application or database. Further, the security system 108 may generate a new password for the sought application or database and/or provide the password to the client device 102.

Although the security system 108 is depicted as communicating directly over the network 126, the security system 108 may also communicate indirectly over the network 126. In one example, the security system 108 may be a part of or otherwise coupled to the client device 102, the manager device 104, the administrator device 106, the security system 108, the routers/switches 110, the firewalls 112, the windows servers 114, the Unix servers 116, the Linux servers 118, the AS/400 servers 120, the z/OS mainframes 122, and the databases 124. Alternately, it will be appreciated that there may be multiple networks and the security system 108 may communicate over all, some, or one of the multiple networks.

The security system 108 may comprise a software library that provides a programmatic interface to the security system 108. In one example, an API library resident on the security system 108 may have a small set of functions that are rapidly mastered and readily deployed in new or existing applications. There may be several API libraries, for example one library for each computer language or technology, such as, Java, .NET or C/C++ languages. Each specific instance, the API library may provide the same set of functions.

The routers/switches may comprise any number of routers and/or switches. In some embodiments, the security system 108 may manage rights or access to one or more routers or switches. The client device 102 may be required to provide a registration request and receive approval before rights to access the routers or switches are approved. The routers/switches 110 may comprise Cisco routers and switches for example. In another example, the routers/switches 110 may comprise a Terminal Access Controller Access-Control System (TACACS). The routers/switches 110 may also comprise web proxies or caches including, but not limited to, BlueCoat Security Gateway devices.

The firewalls 112 may comprise hardware, software, or a combination of both hardware and software. Control to access and manage the firewalls 112 may be controlled by the security system in a method similar to that described herein. In one example, before the user of the client device 102 is permitted to access and/or configure the firewall 112, the client device 102 may be required to provide a registration request that must be approved. In a few examples, the firewalls 112 may comprise Cisco PIX, Netscreen, Nokia IPSO, Check Point, or Cyberguard.

The windows servers 114 may include any server configured with a Microsoft® Windows® operating system. In a few examples, the Microsoft operating system may be Windows 2000, 2003, XP, Media Center, Active Directory, NT 4.0, NT Domains, Vista®, and Windows® 7.

The Unix® servers 116 may include any server configured with a Unix operating system. In a few examples, the Unix® operating system may be Solaris, AIX, HP-UX, Tru64, or UnixWare®. Similarly, the Linux® server 118 may be any server configured with the Linux operating system. In a few examples, the Linux operating system may be Red Hat or Suse.

The AS/400 servers 120 and the z/OS servers 122 may include any server(s) with the associated operating system. Further a server may be configured with RACF, HP iLo, VMware, BoKS, Fujitus RSB, and Radius.

The databases 124 may comprise hardware, software, or a combination of hardware and software. In one example, the databases 124 are on a file server. The databases may include Oracle databases, Microsoft SQL, Sybase, MySQL, DB2 or any other database for example.

It will be appreciated that many operating systems, databases, and applications may be in communication with or otherwise coupled to the network 126. The examples listed herein are not intended to be limiting and other operating systems, databases, and applications may be used in conjunction with various embodiments described herein.

The computer network 126 may provide communication between the client device 102, the manager device 104, the administrator device 106, the security system 108, routers/switches 110, firewalls 112, the windows servers 114, the Unix servers 116, the Linux servers 118, the AS/400 servers 120, the z/OS mainframes 122, and/or databases 124. In some embodiments the network 126 represents one or more network(s) that one or more digital devices may use to communicate. In some examples, the network 126 comprises Ethernet cables, fiber optic, or other wired network topology. In other examples, the network 126 may be wireless and support wireless communication between two or more wireless devices. It will be appreciated that the network 126 may comprise two or more networks, including wired and wireless networks.

Although the routers/switches 110, the firewalls 112, the windows servers 114, the Unix servers 116, the Linux servers 118, the AS/400 servers 120, the z/OS mainframes 122, and the databases 124 are discussed as plural, it will be appreciated that there may be any number of (including one or zero) routers/switches 110, the firewalls 112, the windows servers 114, the Unix servers 116, the Linux servers 118, the AS/400 servers 120, the z/OS mainframes 122, and the databases 124 and be within embodiments described herein.

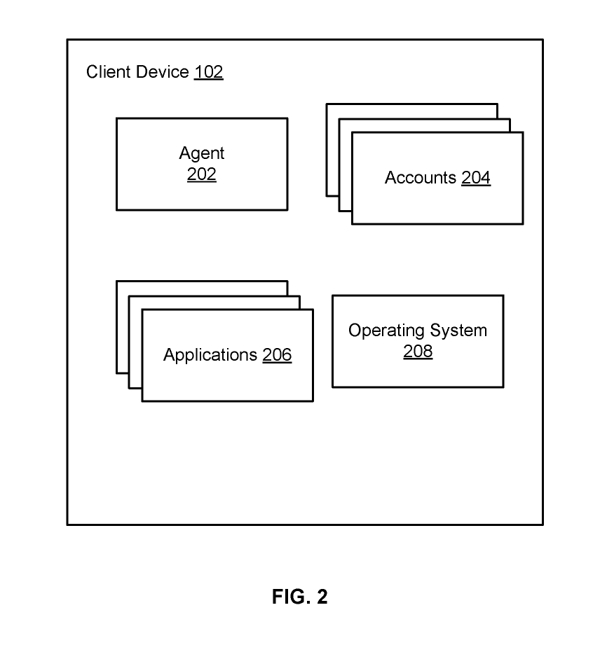

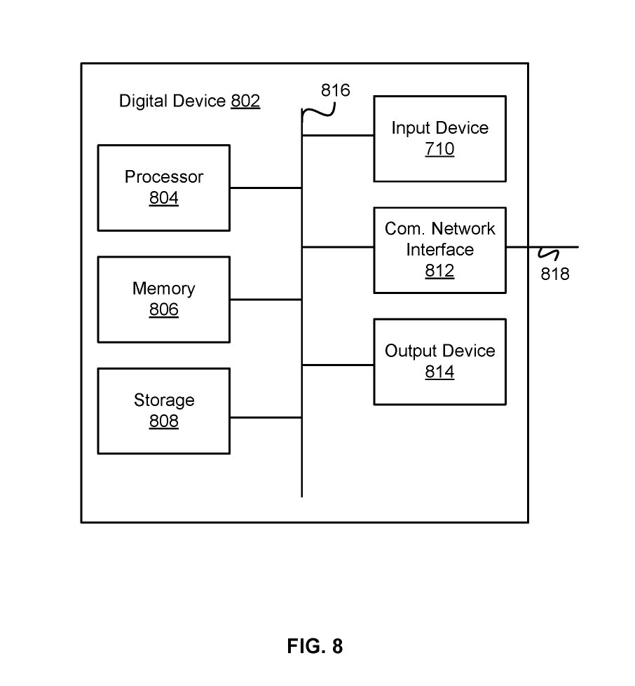

FIG. 2 is a block diagram of one embodiment of a client device comprising a security agent according to some embodiments. FIG. 2 is a block diagram of an example client device 102 according to some embodiments. The client device 102 may be any digital device. Some examples of the client device 102 may include, for example, a mobile device, smartphone, tablet device, laptop, desktop, or hardened device. In some embodiments, the client device 102 comprises a security agent 202, one or more accounts 204, one or more applications 206, and an operating system 208, although in the other embodiments, the client device 102 may be configured otherwise. The security agent 202, the accounts 204, the applications 206 and/or the operating system 208 may be controlled by a processor such as the processor 804 described in relation to FIG. 8 herein.

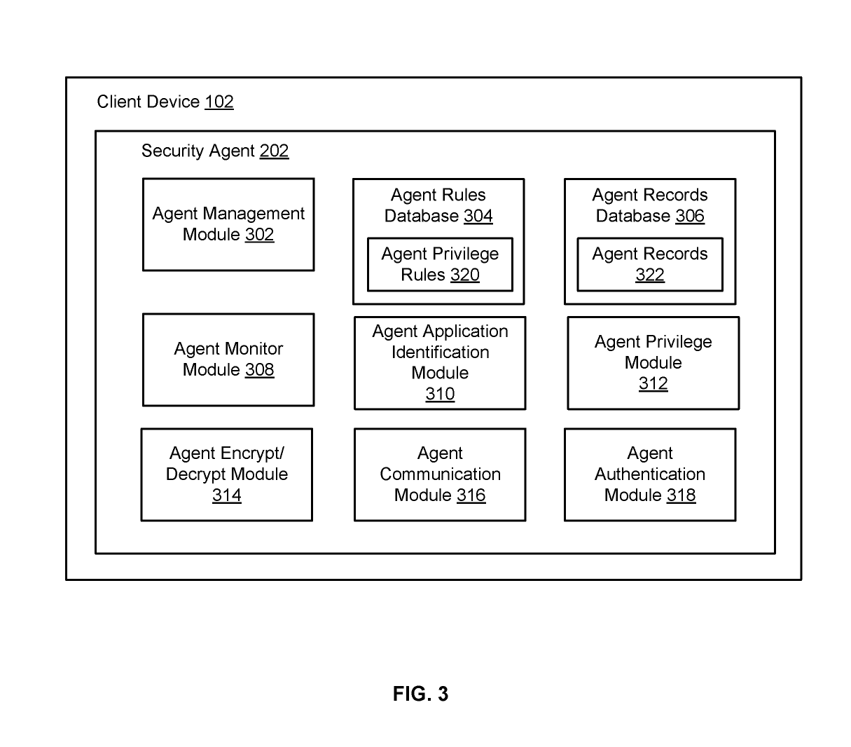

The security agent 202 may be configured to facilitate application control (e.g., cause application execution, deny application execution, etc.) for applications requiring elevated privileges to execute. In some embodiments, the security agent 202 utilizes true elevated privileges to execute such applications. For example, a user associated with a user account may need to execute an application (e.g., an application residing on client device 102 and/or on a remote device) which requires a higher privilege-level to execute than a privilege-level associated with the calling user account. Rather than requiring the user to manually enter a different set of credentials (e.g., administrator credentials), the security agent 202 may facilitate execution, and/or control, of the application with true elevated privileges. The security agent 202 is discussed further below with reference to FIG. 3.

Accounts 204 may include or be linked to any number of accounts. In one example, an account is or is linked to at least one record that enables authentication of credentials (e.g., passwords) to further enable access or other rights to information (e.g., applications, data, records, and/or other accounts).

Accounts 204, for example, may include user accounts, service accounts (e.g., accounts used to launch applications 206), and the like. In some embodiments, the accounts 204 are local to the client device 102 (e.g., not domain-based), and/or domain-based accounts. In various embodiments, each account 204 may be associated with an account identifier and a password. The password may be encrypted and/or stored on the client device 102 and/or the security system 108. In various embodiments, accounts may be associated with hardware of the client device 102 (e.g., credentials necessary to access hardware services or unlock the device). The accounts may be associated with an operating system 208 (e.g., credentials associated with accessing a user profile or device access). There may be any number accounts associated with hardware or services of the client device 102.

In another example, one or more accounts 204 may be associated with information technology (IT) professionals and may be used to enable IT professionals to access an application (e.g., of applications 206), operating system 208, firmware, hardware, and/or any other aspect of the client device 102. In some embodiments, IT professionals may utilize the one or more accounts 204 to maintain the client device 102, perform updates, perform upgrades, troubleshoot, and/or otherwise provide service.

Applications 206 may include any application. An application is any program or executable designed to enable end users to perform specific tasks, such as, but not limited to, word processing, database management, accounting, finance, spreadsheets, or communication. Applications may include, for example, word processing programs, system software, operating systems, browsers, spreadsheets, readers, players, database applications, email applications, design applications, or the like. It will be appreciated that there may be any number of applications 206. In various embodiments, applications 206 comprise applications that have been installed and/or configured by the user of the client device 102, administrator, and/or other trusted individual.

As used in this paper, it will be appreciated that applications may include local applications residing on the client device 102, remote applications, and/or linked applications. Linked applications may include applications executed and/or accessed, either locally or remotely, by an application residing on the client device 102. For example, a client application (e.g., an MS Access client) executing on the client device 102 may require access to a server application (e.g., an MS Access Database) executing on database 124, and the server application may require different privileges than the client application. The security agent 202 may perform the same functionality with regard to linked applications as any other application, e.g., request true elevated privileges, execute with true elevated privileges, and so forth.

In some embodiments, the applications 206 include one or more attributes. The one or more attributes may include, for example, an application identifier (e.g., name, hash value, etc.), version information, linked application(s), privilege-level required to execute the application, and so forth. The one or more attributes may be used, for example, to generate privilege requests 103a, determine if an application requires elevated privileges to execute, and the like.

A rule of the client device 102 may apply to all applications or a subset of applications of the applications 206. In one example, a rule may instruct the client device 102 to allow or deny launch of any application. The rule may instruct the client device 102 to allow or deny launch of any application based on one or more credentials (e.g., password) of the account associated with the application. For example, a rule may instruct the client device 102 to deny application launch if the account used to launch the application does not have sufficient privilege to launch the application. In some embodiments, a rule may instruct client device 102 to request elevated privileges from the security system 108 and/or instruct the client device 102 to execute the application with the elevated privileges, e.g., without requiring input from the user and/or otherwise interrupting their workflow.

Operating system 208 may be any operating system. For example, the operating system 208 may be Microsoft Windows, OSX, Unix, BSD, or any other operating system. In some embodiments, the security agent 202 may include an API and/or a module in communication with the operating system 208 to detect when an application is to be launched or when an active communication connection is available between the client device 102 and the security system 108.

In some embodiments, the client device 102 includes a credential storage that may store passwords and/or other credentials. The credential storage may be on any computer readable media including, for example, storage 808 in FIG. 8 discussed further with regard to FIG. 8. The credential storage may, in some embodiments, be encrypted. The credential storage may, in some embodiments, store passwords received by from the security system 108 and/or generated by the security agent 202.

FIG. 3 is a block diagram of one embodiment of a client device comprising an example security agent according to some embodiments. FIG. 3 is a block diagram of an example client device 102 including an example security agent 202 according to some embodiments. The security agent 202 may be software, hardware, firmware, or a combination thereof. In one example, the security agent 202 is a system (e.g., an application) on the client device 102 configured to generate and/or transmit privilege requests 103a, receive true elevated privileges contained within privilege responses 103b, and/or cause execution of applications with received true elevated privileges. In some embodiments, the security agent 202 executes on the client device 102 and includes an agent management module 302, an agent rules database 304, an agent record database 306, an agent monitor module 308, an agent application identification module 310, an agent privilege module 312, an agent encrypt/decrypt module 314, an agent communication module 316, and an agent authentication module 318.

The agent management module 302 may be configured to create, read, update, delete, and/or otherwise access agent privilege rules 320 stored in the agent rules database 304. Such operations may be performed manually (e.g., by an administrator interacting with a GUI) or automatically (e.g., retrieved from the security system 108). For example, the rules 320 may be generated by the security system 108 and transmitted to the security agent 202 via the network 126. Generally, the rules 320 include instructions to be executed by the security agent 202.

In some embodiments, the rules 320 define a list, or other structure, of applications 206 managed by the security system 108, and may define functions, attributes, and/or conditions for generating privilege requests 103a, processing privilege responses 103b, and/or causing the execution and/or control of applications 206 with true elevated privileges.

In some embodiments, the rules 320 may be associated with applications 206. For example, each rule 320 may be associated with one or more applications 206. The rules 320 may define any of the following attributes and/or conditions:
Rule Identifier: Identifier that uniquely identifies a rule 320.
Rule Name: Name of the rule 320 (e.g., Calc.exe with PBSW)
Applications: Selected applications 206, and/or any selected linked applications 206, associated with the rule 320.
Actions: commands and/or functions associated with the rule 320. For example, actions may include “RUN AS” using true elevated privileges retrieved from the security system 108.
Accounts: Selected accounts 204 associated with the rule 320. Execution of an associated selected application, and/or any selected linked applications, by users associated with the selected accounts 204 may trigger the actions defined in the rule 320.

In some embodiments, the rules 320 may include or specify other information as well, such as encryption and decryption protocols used by the agent encrypt/decrypt module 314, discussed below. It will be appreciated that the agent rules database 304 may be any structure (e.g., active database, relational database, table, and the like) suitable for storing and managing the aforementioned rules 320.

In some embodiments, the agent management module 302 is configured to create, read, update, delete, and/or otherwise access, agent records 322 stored in the agent records database 306, and related data (e.g., account passwords) stored on the client device 102. The agent records 322 may maintain account information (e.g., account identifiers, account names, and the like) and account credentials (e.g., passwords) for the accounts 204 installed on the client device 102.

For example, the agent record database 322 may include an account and/or an account identifier that identifies one of the accounts 204 installed on the client device 102. The account identifier may be a number, character, string, or otherwise. In some embodiments, the records 322 may also include an encrypted password associated with the identified account, although in other embodiments the encrypted password may be stored or managed elsewhere on the client device 102. In some embodiments, the agent records 322 may include one or more rule identifiers that identify corresponding rule(s) 320 stored in the agent rules database 304. It will be appreciated that the agent record database 306 may be any structure (e.g., active database, relational database, table, and the like) suitable for managing and/or storing the aforementioned records 322.

It will be appreciated that the agent records database 306 and records 322 are optional, and that such functionality (e.g., maintain account information, passwords, and the like) may be included in other features of the security agent 202 or client device 102 (e.g., operating system 208).

The agent monitor module 308 may be configured to monitor a client device 102 for a launch of an application (e.g., an application from the set of applications 206) and/or any linked applications. In some embodiments, the agent monitor module 308 is configured to monitor the client device 102 for a launch of an application that requires elevated privileges to execute. In various embodiments, all or part of the agent monitor module 308 intercepts and/or otherwise receives calls to the operating system 208 to launch an application. In various embodiments, all or part of the agent monitor module 308 may have hooks within the operating system 208 (e.g., the monitor module may have hooks in the kernel). The agent monitor module 308 may detect commands or calls to launch an application or may intercept such commands or calls.

The agent application identification module 310 may be configured to identify the launching application, and/or any linked applications, and/or one or more attributes of the launching application, and/or one or more attributes of any linked applications. For example, the agent application identification module 310 may identify the launching application as well as the launching application's version. All or part of the agent application identification module 310 may be within or in communication with the operating system 208, resident in memory (e.g., RAM) of the client device 102, or in communication with any component(s) of the client device 102.

In various embodiments, prior to the application being commanded to launch, the agent application identification module 310 may scan all or parts of the client device 102 to identify applications and/or attributes (e.g., application identifiers, application versions, privilege level(s) required to execute the application, etc.) of the application or account seeking to launch the application. The application attributes may be stored or cached. When the agent application identification module 310 detects a command or call to launch the application, the agent application identification module 310 may identify the launching application based on the previously stored or cached information.

In some embodiments, the agent application identification module 310 retrieves an application identifier from a stored plurality of application identifiers. The retrieval of the application identifier may be based on information from scanning the directory of the launching application. The application identifier may be a name of an application, a value (e.g., code), a hash, or any other information that may identify the launching application.

In various embodiments, the agent application identification module 310 may also identify various attributes of the account seeking to launch the application. In some embodiments, the agent application identification module 310 may identify an account name, an account identifier, an account privilege level or status (e.g., normal user, administrator, etc.), and so forth. For example, it may detect if the user or account calling to launch the application is signed in as a trusted or elevated account (e.g., whether the account has active administrative or super-user privilege status). Those skilled in the art will appreciate that the account identifier may be a number, character, string, or other identifier sufficient to identify an account, e.g., from the set of accounts 206.

The agent privilege module 312 may be configured to execute agent privilege rules 320 to cause the execution and/or control of applications with true privilege elevation. For example, the agent privilege module 312 may cause the application to be executed with the “RUN AS” command. In some embodiments, the agent privilege module 312 may generate a privilege request 103a when an instruction is detected to execute an application requiring elevated privileges. The privilege request message 103a may include, among other things, one or more attributes of the associated application 206, characteristics and/or attributes of the client device 102 and/or accounts 204 installed thereon. The characteristics and/or attributes may include for example, a device identifier, a device name, a fully qualified domain name (FQDN), a domain name, an IP address, a MAC address, an account name, an account identifier, a user name, a user ID, a CPU ID, a CPU serial number, a root disk volume, an OS version, an OS type, and so forth. It will be appreciated that the device identifier and the account identifier may be a number, character, string, or other identifier that may each identify, at least with respect to the client device 102 and the security system 108, the device and account associated with those identifiers.

In some embodiments, the agent privilege module 312 may also be configured to update any number of rules 320 based upon update messages received from the security system 108. The agent privilege module 312 may receive one or more rules from the privilege response messages 103b sent from the security system 108. In some embodiments, the agent privilege module 312 may generate new rules based on information received from the security system 108. In one example, the agent privilege module 312 may look up a rule in the rule database 304 with a rule identifier specified in the received update message, and replace the existing “old” rule with the “new” rule contained in the received message. Alternatively, the agent privilege module 312 may upon only update a portion of the rule (e.g., a trigger condition) as opposed to replacing the whole rule.

The agent communication module 316 may be configured to provide communication between the client device 102 and the security system 108. In some embodiments, the communication module 316 may also be configured to communicate between the security agent 202 and the security system 108. For example, the agent communication module 316 may establish an active (or, real-time) communication connection between the client device 102 and the security system 108, and the security agent 202 may send privileges requests 103a, and/or receive privilege response 103b, via that connection.

The agent encrypt/decrypt client module 314 is configured to encrypt, decrypt, and/or otherwise secure information during communication between the client device 102 and the security system 108 and/or information stored by the security agent 202. The encrypt/decrypt client module 212 may encrypt, decrypt, or otherwise secure information in any number of ways including, but not limited to, those described herein. For example, agent encrypt/decrypt client module 314 may encrypt privilege requests 103a sent to the security system 108, and decrypt privilege responses 103b received from the security system 108. In some embodiments, the encryption/decryption protocols utilized by the agent encrypt/decrypt client module 314 are defined in the rules 320.

In some embodiments, the agent authentication module 318 may be configured to authenticate a source of incoming messages (e.g., privilege responses 103b). The agent authentication module 318 may authenticate incoming messages, for example, based upon authentication data contained within the incoming messages. This may prevent, among other things, “man in the middle” attacks. In some embodiments, the rules for appropriately authenticating a source of incoming privilege responses 103b may be defined in rules 320. Authentication may utilize, for example, challenge messages, encryption, 3^{rd} party authentication, and the like.

It will be appreciated that a “module,” “agent,” or “database” may be or comprise software, hardware, firmware, and/or circuitry. In one example, one or more software programs comprising instructions capable of being executable by a processor (e.g., processor 804 described with regard to FIG. 8) may perform one or more of the functions of the modules, databases, or agents described herein. In another example, circuitry may perform the same or similar functions. The circuitry may utilize, for example, an ASIC or other processing device.

Alternative embodiments may comprise more, less, or functionally equivalent modules, agents, or databases, and still be within the scope of present embodiments. For example, as previously discussed, the functions of the various modules, agents, or databases may be combined or divided differently. It will also be appreciated that some of the modules identified in FIG. 3 are optional (e.g., the agent encrypt/decrypt module 314 and the agent authentication module 318 may be optional).

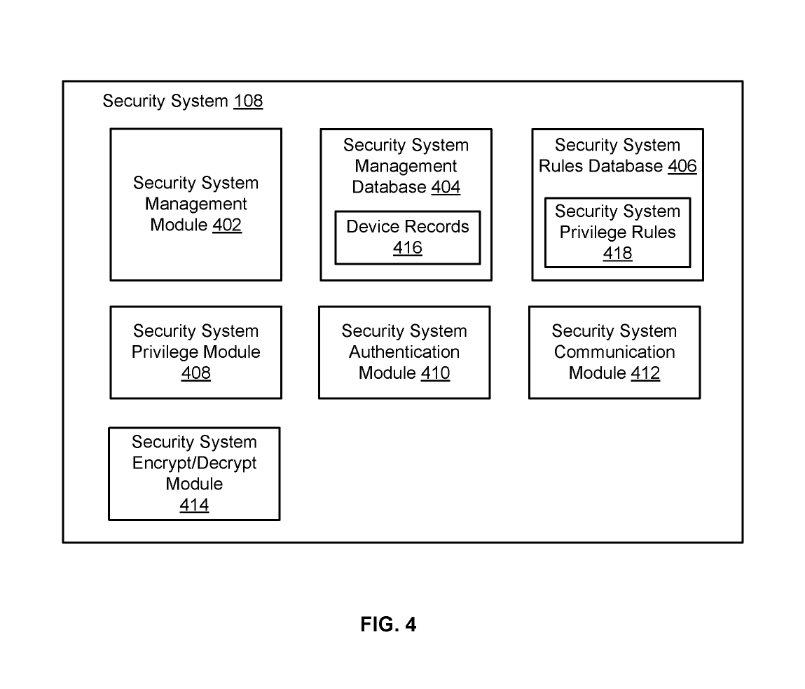

FIG. 4 is a block diagram of one embodiment of a security system according to some embodiments. FIG. 4 is a block diagram of an example security system 108 according to some embodiments. In some embodiments, the security system 108 includes a security management module 402, a security system management database 404, a security system rules database 406, a security system privilege module 408, a security system authentication module 410, a security system communication module 412, and a security system encrypt/decrypt module 414. The security system 108 may be configured to approve or deny privilege requests 103a, retrieve true elevated privileges for approved requests 103a, and/or generate privilege responses 103b.

The security management module 402 is configured to create, read, update, delete, and/or otherwise access, device records 416 stored in the security system management database 404 and the rules 418 stored in the rules database 406. The security management module 402 may perform any of these operations either manually (e.g., by an administrator interacting with a GUI) or automatically (e.g., by the security system privilege module 408). In some embodiments, any of device records 416 store a variety of information about the client device 102 and/or other devices that connect to the security system 108 (e.g., via network 126). For example, the device records 405 could store device identifiers (e.g., MAC addresses, IP addresses, Firmware identifiers, or the like), account identifiers, rule identifiers, security agent identifiers, passwords, password identifiers, application identifiers, log entries, log entry identifiers, network connection status identifiers, password status (e.g., current, expired, requires updating, and the like) and so forth.

In some embodiments, each device record 416 may include a digital device identifier that identifies a client device 102 in communication with the security system 108. For example, a device record 416 may include a device identifier that identifies client device 102. The device records 416 may also include an encrypted password associated with the digital device identifier, and a rule identifier that identifies a rule from a set of rules 418. In some embodiments, each of the device records 416 may include a password identifier instead of the password itself. That password identifier may identify an encrypted password stored elsewhere on the security system 108, or other device connected thereto.

It will be appreciated that the device records 416 may not include a password. In some embodiments, a device record may identify when a password was last changed on a device and/or account. The device record may further indicate whether a change of password is due or whether a change is not due.

In some embodiments, the rules 418 are each associated with one or more applications 206. The rules 418 may define various attributes, e.g., a rule identifier, a rule name, a rule description, associated application(s), one or more actions to be taken, a privilege-level required to execute the associated application(s), an elevated account identifier for an account with privileges sufficient to execute the associated application(s), and so forth. In some embodiments, the rules 418 may also include one or more account names, or other account identifiers, for selected accounts that are associated with the rule.

For example, a rule 418 may be named “Calc with PBPS Run As” and specify that associated user accounts 206 may execute the Windows CALC.EXE application with account credentials stored on the security system 108 or otherwise. The associated accounts 206 may be specifically defined in the rule 418, or they may be separately defined by the agent 202 or security system 108 (e.g., by a table or other data structure defining associations between the rules and applicable accounts or groups of accounts). In some embodiments, the rules 418 may also define encryption/decryption protocols used by the security system encrypt/decrypt module 414, discussed below.

In some embodiments, the rules 418 may define any of the following attributes and/or conditions:
Rule Identifier: Identifier that uniquely identifies a rule 418.
Rule Name: Name of the rule 418 (e.g., Calc.exe with PBSW)
Applications: Selected applications 206, and/or any selected linked applications 206, associated with the rule 418.
Actions: commands and/or functions associated with the rule 418. For example, actions may include “RUN AS” using true elevated privileges retrieved from the security system 108.
Accounts: Selected accounts 204 associated with the rule 418. Execution of an associated selected application, and/or any selected linked applications, by users associated with the selected accounts 204 may trigger the rule 418.

In some embodiments, the security system management module 402 comprises a library of executable instructions each of which may be executable by a processor (e.g., a processor 804 further described with regard to FIG. 8) for performing any of the aforementioned operations. The library may comprise any number of methods (e.g., one or more programs) stored in the library may be configured to change the password to an SQL database. It will be appreciated that the security system management database 404 may be any structure (e.g., active database, relational database, table, and so forth, and the like) suitable for storing the aforementioned records.

The security system privilege module 408 may be configured to execute rules 418 to approve or deny privilege requests 103a, retrieve true elevated privileges for approved requests 103a, and/or generate privilege responses 103b.

The security system authentication module 410 may be configured to authenticate a source of messages sent to the security system 108. Thus, for example, the security system authentication module 410 may verify that the privilege request 103a actually originated from the client device 102, as opposed to an illegitimate device, such as a device used by a hacker in a man-in-the-middle attack. The security system authentication module 410 may authenticate a source of incoming messages based on authentication data included in the message.

The security system communication module 412 may be configured to provide communication between the security system 108 and the client device 102. In some embodiments, the security system communication module 412 may also be configured to communicate between the security system 108 and the security agent 202. The security system communication module 412 may also be configured to establish an encrypted communication (e.g., VPN, HTTPS, SSL, and so forth) with the client device 102 and/or the security agent 202.

The security system encrypt/decrypt module 414 may be configured to provide encryption, decryption, or other security measures for the security system 108. For example, the security system encrypt/decrypt module 414 may be able to encrypt privilege response 103b sent to the client device 102, and decrypt privilege requests 103a received from the client device 102. In some embodiments, the security system encrypt/decrypt module 414 issues a program key. A program key may be an SSH DSS private key or an X509v3 client certificate, for example. The security system 108 may issue a program key for use on behalf a program account. In some embodiments, the program key may be a required parameter for API functions.

In some embodiments, the security system 108 does not allow direct access to the operating system on the security system 108. Further, the security system 108 may comprise a firewall (e.g., with IPSEC support) to prevent hacking. Moreover, the security system 108 may perform encryption, such as FIPS-140 validated components, and perform hard disk AES 256-bit encryption for whole disk encryption. Passwords, once generated, may be stored with x509v3 certificates. In some embodiments, inbound connections may be only through HTTPS and SSH. The security system 108 may also support single- or two-factor authentication using LDAP Active Directory, SecureID, Safeword, and x509v3 certificates. The security system 108 may perform any or more than the functions listed herein.

As discussed herein, one or more software programs comprising instructions capable of being executable by a processor (e.g., processor 804 described with regard to FIG. 8) may perform one or more of the functions of the modules, databases, or agents described herein. In another example, circuitry may perform the same or similar functions. The circuitry may utilize, for example, an ASIC or other processing device.

Alternative embodiments may comprise more, less, or functionally equivalent modules, agents, or databases, and still be within the scope of present embodiments. For example, as previously discussed, the functions of the various modules, agents, or databases may be combined or divided differently. It will also be appreciated that some of the modules identified in FIG. 4 are optional.

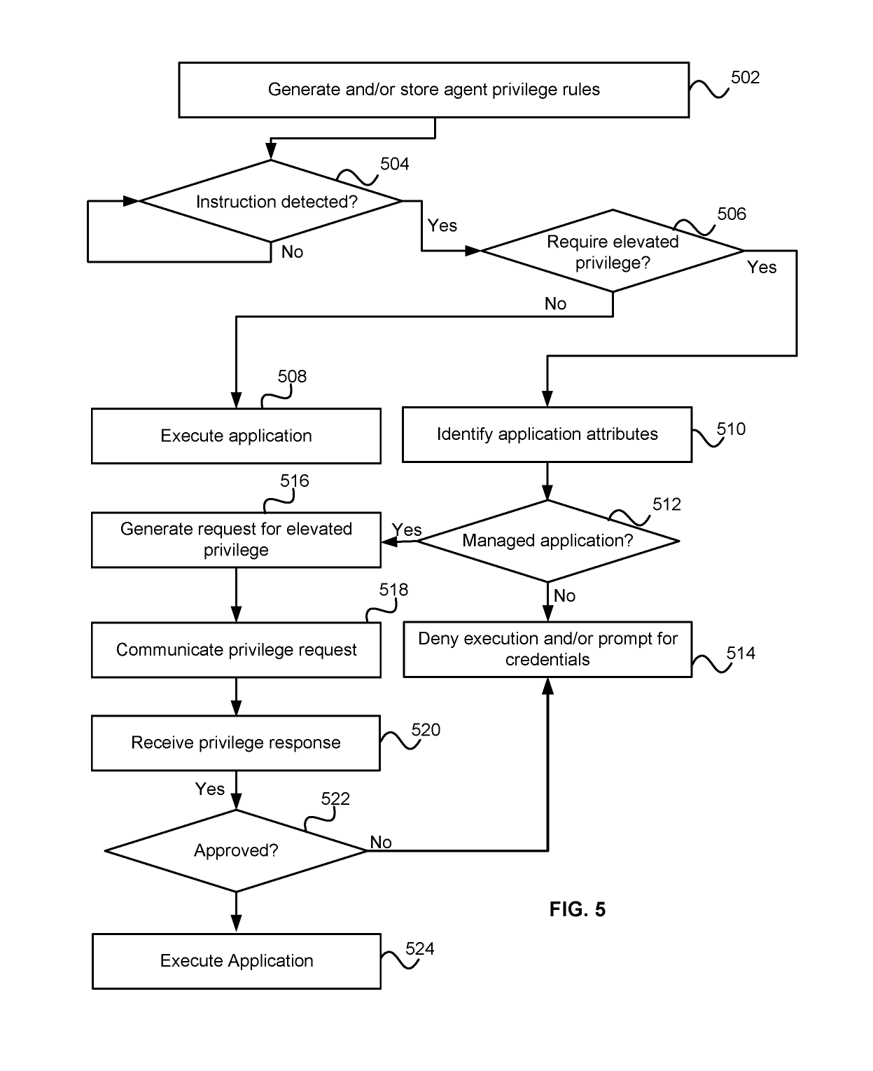

FIG. 5 is a flow block diagram of one embodiment of a method of operation for an example security agent according to some embodiments. FIG. 5 is an example method of operation for an example security agent 202 according to some embodiments. In some embodiments, operation of the security agent 202 may include a greater or lesser number of such steps.

In step 502, the security agent 202, executed by client device 102, generates and/or stores agent privilege rules 320. The privilege rules 320 may be stored in a memory that may be hardware (e.g., SSD, HDD, RAM, and the like), software (e.g., database, table, and so forth), or combination thereof. The agent privilege rules 320 may include, for example, a list of applications managed by the security system 108, associated accounts 204 and/or applications 206, and so forth. In some embodiments, the agent privilege rules 320 are generated by a security agent management module 302, and/or retrieved from the security system 108, and stored in rules database 304.

In step 504, the security agent 202 detects and/or intercepts an instruction to execute an application and/or any linked applications. For example, the application may be a local application 206 residing on the client device 102, and a linked application may be an application residing on a remote device (e.g., database 124). The applications may be linked via a network (e.g., network 126).

In various embodiments, the security agent 202 may detect and/or intercept instructions to execute any of the applications 206, and/or a subset of the applications 206. For example, a subset of the applications 206 may comprise applications managed by the security system 108, e.g., as defined by the agent privilege rules 320. By way of further example, if an instruction is detected for an application which is not managed by the security system 108, the security agent 202 may ignore the instruction and allow the instruction be processed without interception and/or further interruption. In some embodiments, rather than intercepting the instruction, the security agent 202 may terminate the instruction and/or issue a new instruction to execute the application. In various embodiments, the agent monitor module 308 may detect, intercept, and/or terminate instructions to execute an application and/or any linked applications.

In step 506, the security agent 202 determines whether an elevated privilege is required to execute an application and/or any linked applications. For example, the security agent 202 may determine that a user launching a client application (e.g., an MS Access database client application) on the client device 102 may have sufficient privileges to successfully launch that client application, but insufficient privileges to launch a linked server application (e.g., MS Access database server application) on a remote device (e.g., database 124). Accordingly, the security agent 202 may determine an elevated privilege is required for the linked application. In some embodiments, the agent monitor module 508 may determine if the application and/or any linked applications require elevated privileges.

In step 508, if an elevated privilege is not required to execute the application and/or any linked applications, the security agent 202 may let application execution proceed without further intervention. In step 510, if an elevated privilege is required for the application and/or any linked applications, the security agent 202 may identify one or more attributes of the application and/or linked applications requiring the privilege elevation. In some embodiments, agent application identification module 310 may identify the one or more application attributes.

In step 512, the security agent 202 may determine if the application and/or any linked applications requiring elevated privileges are managed by the security system 108. If the application and/or any linked applications requiring elevated privileges are not managed by the security system 108, e.g., as determined based on rules 320, the security agent 202 may deny application execution and/or prompt the user for elevated credentials (step 514). In some embodiments, the agent privilege module 312 may determine if the application and/or any linked applications requiring elevated privileges are managed by the security system 108.

In step 516, the security agent 202 may generate a privilege request 103a. The privilege request 103 may be based on the one or more identified application attributes and/or associated rules 320. For example, the privilege request 103a may include an application identifier associated with the application requiring elevated privileges, an account identifier associated with the user that issued the instruction to execute the application requiring elevated privileges, a client device identifier associated with the application requiring elevated privileges, and so forth. In some embodiments, agent privilege module 312 and/or the agent communication module 316 may generate the privilege request 103a.

In step 518, the security agent 202 may communicate the privilege request 103a to the security system 108. In some embodiments, the request 103a may be encrypted by agent encrypt/decrypt module 314, and/or the agent communication module 316 may communicate the request 103a via network 126.

In step 520, the security agent 202 may receive a privilege response 103b from the security system 108. If the request 103a was denied (step 522) by the security system 108, the response 103b may deny application execution and/or prompt the user from elevated credentials (step 514). If the request 103a was approved by the security system 108, the privilege response 103b may include true elevated privileges. For example, the true elevated privileges may comprise account credentials (e.g., username and password) associated with an administrator account. In some embodiments, agent communication module 316 may receive the privilege response 103b, agent authentication module 318 may authenticate a source of the response 103b (e.g., security system 108), and/or agent encrypt/decrypt module 314 may decrypt the response 103b.

In step 524, if the request 103a was approved by the security system 108, the security agent 202 may cause the execution of the application and/or any linked applications requiring elevated privileges. For example, the application and/or any linked applications may be executed with a “RUN AS” command using the true elevated privileges included in the privilege response 103b. In some embodiments, the security agent 202 may terminate the detected instruction and cause a new execution of the application and/or linked applications using the true elevated privileges included in the privilege response 103b. In some embodiments, agent privilege module 312 may cause the execution of the application and/or linked applications based on one or more associated rules 320.

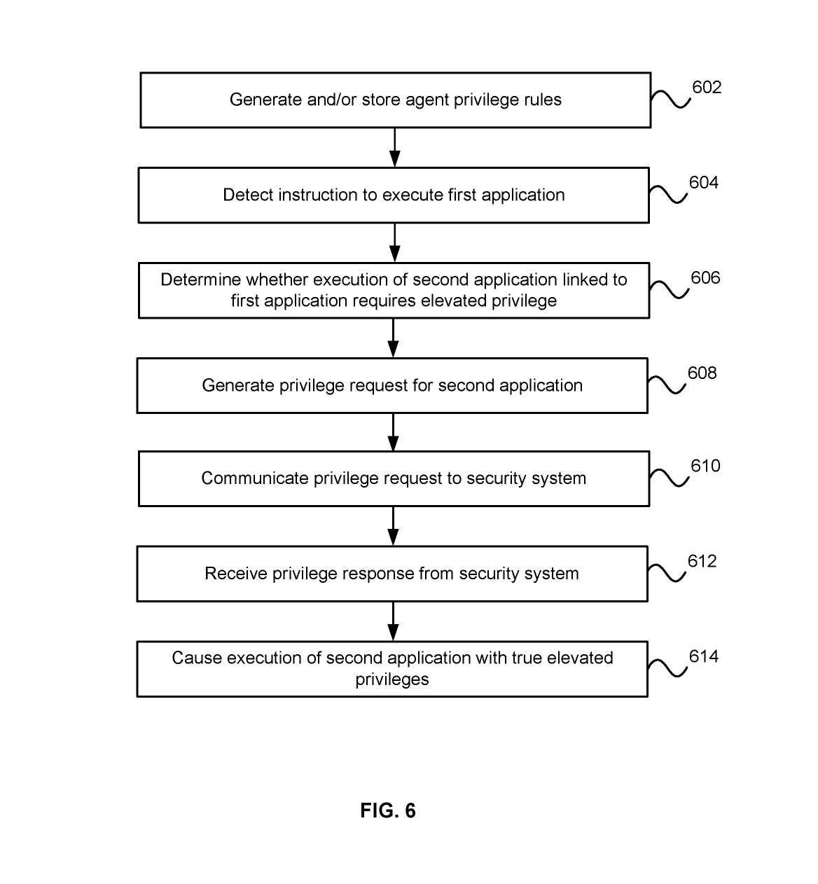

FIG. 6 is a flow block diagram of one embodiment of a method of operation for an example security agent according to some embodiments. FIG. 6 is an example method of operation for an example security agent 202 according to some embodiments. In some embodiments, operation of the security agent 202 may include a greater or lesser number of such steps.

In step 602, the security agent 202, executed by client device 102, generates and/or stores agent privilege rules 320. The privilege rules 320 may be stored in a memory that may be hardware (e.g., SSD, HDD, RAM, and the like), software (e.g., database, table, and so forth), or combination thereof. The agent privilege rules 320 may include, for example, a list of applications managed by the security system 108, associated accounts 204 and/or applications 206, and so forth. In some embodiments, the agent privilege rules 320 are generated by a security agent management module 302, and/or retrieved from the security system 108, and stored in agent rules database 304.

In step 604, the security agent 202 detects and/or intercepts an instruction to execute a first application 206 on the client device 102. For example, the first application 206 may be a client application, such as an MS Access database client application. In some embodiments, agent monitor module 308 detects and/or intercepts the instruction.

In various embodiments, the security agent 202 may detect and/or intercept instructions to execute any of the applications 206, and/or a subset of the applications 206, as discussed above. In some embodiments, as discussed above, rather than intercepting the instruction, the security agent 202 may terminate the instruction and/or issue a new instruction to execute the application. In various embodiments, the agent monitor module 308 may detect, intercept, and/or terminate instructions to execute an application and/or any linked applications.

In step 606, the security agent 202 determines whether execution of a second application (or, linked application) linked to the first application, e.g., via network 126, requires an elevated privilege. For example, the second application may be a server application, such as an MS Access database server application (e.g., residing on databases 124). In some embodiments, the agent privilege module 312 determines whether the elevated privilege is required for the second application based on one or more associated rules 320.

In step 608, if the second application requires the elevated privilege to execute, the security agent 202 may generate a privilege request 103a. The privilege request 103 may be based on one or more associated rules 320. For example, the privilege request 103a may include an application identifier associated with the first application and/or second application, an account identifier associated with the user that issued the instruction to execute the first application, a client device identifier(s) associated with the first application and/or second application, and so forth. In some embodiments, agent privilege module 312 and/or the agent communication module 316 may generate the privilege request 103a.

In step 610, the security agent 202 may communicate the privilege request 103a to the security system 108. In some embodiments, the request 103a may be encrypted by agent encrypt/decrypt module 314, and/or the agent communication module 316 may communicate the request 103a via the network 126.

In step 612, the security agent 202 may receive a privilege response 103b from the security system 108. If the request 103a was approved by the security system 108, the privilege response 103b may include true elevated privileges. For example, the true elevated privileges may comprise account credentials (e.g., username and password) associated with an administrator account. In some embodiments, the agent communication module 316 may receive the privilege response 103b, agent authentication module 318 may authenticate a source of the response 103b (e.g., security system 108), and/or agent encrypt/decrypt module 314 may decrypt the response 103b.

In step 614, the security agent 202 may cause the execution of the first application and/or second application using the true elevated privileges included in the privilege response 103b. For example, the first application and/or second application may be executed with a “RUN AS” command using the true elevated privileges included in the privilege response 103b. In some embodiments, the security agent 202 may terminate the detected instruction and cause a new execution of the first application and/or second application using the true elevated privileges included in the privilege response 103b. In some embodiments, the agent privilege module 312 may cause the execution of the first application and/or second application based on one or more associated rules 320.

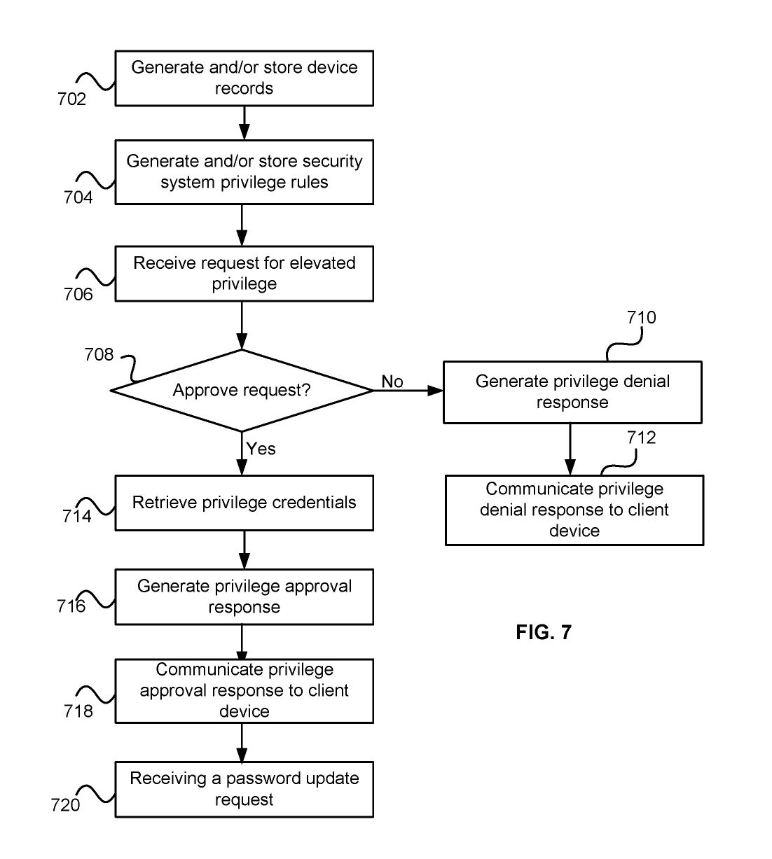

FIG. 7 a flow block diagram of one embodiment of a method of operation for an example security system according to some embodiments. FIG. 7 is an example method of operation for an example security system 108 according to some embodiments. In some embodiments, operation of the security system 108 may include a greater or lesser number of such steps.

In step 702, the security system 108 generates and stores device records 416 in a memory. The memory may be hardware (e.g., SSD, HDD, RAM, and any other kind of computer readable media), software (e.g., database 404), or combination thereof. In some embodiments, the security management module 402 generates and/or stores the device records 416.

In step 704, the security system 108 generates and stores security system privilege rules 418. The security system privilege rules 418 may be stored in a memory that may be hardware (e.g., SSD, HDD, RAM, and the like), software (e.g., database, table, and so forth), or combination thereof. The security system privilege rules 418 may include, for example, a list of applications managed by the security system 108, associated accounts 204 and/or applications 206, and so forth. In some embodiments, the security system privilege rules 418 are generated by a security system management module 402, and/or stored in rules database 406.

In step 706, the security system 108 may receive a privilege request 103a from the client device 102. In some embodiments, the communication module 412 may receive the request 103a, the authentication module 410 may authenticate a source of the request (e.g., client device 102), and/or encrypt/decrypt module 414 may decrypt the request 103a.

In step 708, the security system 108 may approve or deny the request 103a. In some embodiments, security system privilege module 408 approves or denies the request 103a based on one or more associated rules 418.

In step 710, if the request 103a is denied, the security system 108 may generate a denial response 103b and communicate the denial response to the client device 102 (step 712). In some embodiments, the security system privilege module 408 and/or communication module 412 may generate and/or transmit the denial response 103b. In some embodiments, the encrypt/decrypt module 414 may encrypt the denial response 103b prior to transmission to the client device 102.

In step 714, if the request 103a is approved, the security system 108 may retrieve true elevated privileges based on the request 103a and/or an associated rule 418. In some embodiments, the security system privilege module 408 may retrieve the true elevated privileges.

In step 716, the security system 108 may generate privilege response 103b and/or transmit the response 103b to the client device 102 (step 718). For example, the privilege response 103b may include the retrieved true elevated privileges. In some embodiments, the security system privilege module 408 and/or communication module 412 may generate and/or transmit the response 103b. In some embodiments, the encrypt/decrypt module 414 may encrypt the response 103b prior to transmission to the client device 102.

In step 720, the security system 108 may receive a password update request.

FIG. 8 is a block diagram of one embodiment of a digital device according to some embodiments. FIG. 8 is a block diagram of an example digital device 802 according to some embodiments. Any of the client device 102, the manager device 104, the administrator device 106, the security system 108, routers/switches 110, firewalls 112, the windows servers 114, the Unix servers 116, the Linux servers 118, the AS/400 servers 120, the z/OS mainframes 122, and databases 124 may be an instance of the digital device 802. The digital device 802 comprises a processor 804, memory 806, storage 808, an input device 810, a communication network interface 812, and an output device 814 communicatively coupled to a communication channel 816. The processor 804 is configured to execute executable instructions (e.g., programs). In some embodiments, the processor 804 comprises circuitry or any processor capable of processing the executable instructions.

The memory 806 stores data. Some examples of memory 806 include storage devices, such as RAM, ROM, RAM cache, virtual memory, and so forth. In various embodiments, working data is stored within the memory 806. The data within the memory 806 may be cleared or ultimately transferred to the storage 808.

The storage 808 includes any storage configured to retrieve and store data. Some examples of the storage 808 include flash drives, hard drives, optical drives, and/or magnetic tape. Each of the memory system 806 and the storage system 808 comprises a computer-readable medium, which stores instructions or programs executable by processor 804.

The input device 810 is any device that inputs data (e.g., mouse and keyboard). The output device 814 outputs data (e.g., a speaker or display). It will be appreciated that the storage 808, input device 810, and output device 814 may be optional. For example, the routers/switchers 110 may comprise the processor 804 and memory 806 as well as a device to receive and output data (e.g., the communication network interface 812 and/or the output device 814).

The communication network interface (com. network interface) 812 may be coupled to a network (e.g., network 126) via the link 818. The communication network interface 812 may support communication over an Ethernet connection, a serial connection, a parallel connection, and/or an ATA connection. The communication network interface 812 may also support wireless communication (e.g., 802.11 a/b/g/n, WiMax, LTE, Wi-Fi). It will be apparent to those skilled in the art that the communication network interface 812 may support many wired and wireless standards.

It will be appreciated by those skilled in the art that the hardware elements of the digital device 802 are not limited to those depicted in FIG. 8. A digital device 802 may comprise more or less hardware, software and/or firmware components than those depicted (e.g., drivers, operating systems, touch screens, biometric analyzers, and so forth). Further, hardware elements may share functionality and still be within various embodiments described herein. In one example, encoding and/or decoding may be performed by the processor 804 and/or a co-processor located on a GPU (i.e., Nvidia).

It will further be appreciated that although the example method steps described herein (e.g., steps 502-524, 602-624, and 702-718) are described in a specific order, each of the steps may also be performed in a different order. Each of the steps may also be performed sequentially and/or in parallel with one or more of the other steps. In other embodiments, the methods may include a lesser or greater number of such steps.

The above-described functions and components may comprise instructions that are stored on a storage medium such as a computer readable medium. Some examples of instructions include software, program code, and firmware. The instructions may be retrieved and executed by a processor in many ways.

The systems and methods described herein are with reference to example embodiments. It will be appreciated that various modifications may be made and other embodiments may be used without departing from the broader scope of the present disclosure. Therefore, these and other variations upon the example embodiments are intended to be covered by the present disclosure.

The methods and systems disclosed herein are not limited to a particular hardware or software configuration, and may find applicability in many computing or processing environments. The methods and systems may be implemented in hardware or software, or a combination thereof. The methods and systems may be implemented in one or more computer programs, where a computer program may be understood to include one or more processor executable instructions. The computer program(s) may execute on one or more programmable processors, and may be stored on one or more storage mediums (i.e., computer readable medium) readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation. Those skilled in the art will appreciate that the RAM, RAID, floppy disks, optical medium (e.g., CD and DVD disks), magnetic disks, internal hard drive, external hard drive, memory stick or other storage device may also be computer readable mediums.

The computer program(s) may be implemented using one or more high level procedural or object-oriented programming languages to communicate with a computer system. However, the program(s) may be implemented in assembly or machine language, if desired. The language may be compiled or interpreted.

The processor(s) may be embedded in one or more devices that may be operated independently or together in a networked environment, where the network may include, for example, a local area network (LAN), wide area network (WAN), an intranet, the Internet, and/or another network. The network(s) may be wired, wireless, or a combination thereof and may utilize one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single or multiple processor/devices.

The device(s) (e.g., computers) that integrate with the processor(s) may include, without limitation, for example, a personal computer(s), workstation (e.g., Sun®, Hewlett Packard®), personal digital assistant (PDA), handheld device such as cellular telephone, laptop, handheld, or another device capable of being integrated with a processor(s) that may operate as provided herein. Accordingly, the devices provided herein are not exhaustive and are provided for illustration and not limitation. Similarly, as used herein a system may be a single digital device (e.g., a computer) or may comprise multiple digital devices.

As used herein, the terms “microprocessor” and “processor,” may be understood to include one or more microprocessors that may communicate in a stand-alone and/or a distributed environment(s), and may thus may be configured to communicate via wired or wireless communications with other processors, wherein such one or more processor may be configured to operate on one or more processor-controlled devices that may be similar or different devices. Use of such “microprocessor” or “processor” terminology or the like may thus also be understood to include a central processing unit, an arithmetic logic unit, an application-specific integrated circuit (IC), and/or a task engine, with such examples provided for illustration and not limitation.

Furthermore, memory, unless otherwise specified, may include, without limitation, one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix®, Oracle®) and also proprietary databases, and may also include other structures for associating memory such as links, queues, graphs, trees, with such structures provided for illustration and not limitation.

References to a network, unless provided otherwise, may include, without limitation, one or more intranets and/or the Internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art. Accordingly, it will be understood that the disclosed methods and systems are not to be limited to the embodiments disclosed herein, may include practices otherwise than specifically described, and are to be interpreted as broadly as allowed under the law.

The methods and systems described herein may be deployed in part or in whole through a machine that executes computer software, application, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, in some embodiments, other devices may be required for execution of methods as described in this application may be considered as a part of the infrastructure associated with the server.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, in some embodiments, other devices may be required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the embodiments discussed herein. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While various embodiments have been disclosed and described in detail, various modifications and improvements thereon will become readily apparent to those skilled in the art. Accordingly, the spirit and scope of the present description is not to be limited by the foregoing examples, but is to be understood in the broadest sense allowable by law.

All documents referenced herein are hereby incorporated by reference.

While the foregoing written description enables one of ordinary skill to make and use what is considered presently to be the best mode thereof, those of ordinary skill will understand and appreciate the existence of variations, combinations, and equivalents of the specific embodiment, method, and examples herein. These embodiments therefore are not be limited by the above described illustrated embodiments, methods, and examples, but by all embodiments and methods within the scope as claimed.

Except as stated immediately above, nothing which has been stated or illustrated is intended or should be interpreted to cause a dedication of any component, step, feature, object, benefit, advantage, or equivalent to the public, regardless of whether it is or is not recited in the claims.

We claim:

1. A computer-implemented method for true privilege application elevation, the steps comprising:
providing a client device;
storing, by said client device, at least one privilege rule;
detecting, by said client device, an instruction to execute an application;
determining, by said client device, whether execution of said application requires an elevated privilege;
generating, by said client device, a request for said elevated privilege based on said at least one privilege rule;
communicating said request for said elevated privilege to a security system that is in operative communication with said client device;
receiving, by said client device, a privilege response from said security system;
wherein said privilege response is a response selected from the group of responses selected from: an approval and a denial;
wherein if said privilege response is said approval, then said application is executed with said elevated privilege.

2. The method of claim 1, wherein if said privilege response is said approval said privilege response comprises one or more true elevated privileges.

3. The method of claim 1, further comprising the steps:
identifying, responsive to determining the execution of said application requires said elevated privilege, one or more attributes of said application;
wherein said request for said elevated privilege is further based on said one or more attributes of said application.

4. The method of claim 3, wherein said client device comprises a security agent;
wherein said security agent comprises an agent management module, and comprises an agent rules database that stores said at least one privilege rule.

5. The method of claim 4, wherein said at least one privilege rule is generated by said agent management module or is retrieved from said security system.

6. The method of claim 5, wherein said security agent further comprises an agent communication module that receives said privilege response and an agent authentication module that authenticates a source of said privilege response.

7. The method of claim 6, wherein said security agent further comprises an agent encrypt/decrypt module that decrypts said privilege response.

8. The method of claim 7, wherein said agent encrypt/decrypt module encrypts said request for said elevated privilege and wherein said agent communication module communicates said request for said elevated privilege to said security system.

9. A computer-implemented method for true privilege application elevation, the steps comprising:
providing a client device;
storing, by said client device, at least one privilege rule;
detecting, by said client device, an instruction to execute a first application;
determining, by said client device, whether execution of a second application on a remote device requires an elevated privilege, said second application linked to said first application via said network connection;
generating, by said client device, a request for said elevated privilege for said second application based on said at least one privilege rule;
communicating said request for said elevated privilege to said security system that is linked to said client device via a network connection;
receiving, by said client device, a privilege response from said security system;
wherein said privilege response is a response selected from the group of responses selected from: an approval and a denial;
wherein if said privilege response is said approval, then said second application is executed with said elevated privilege.

10. The method of claim 9, wherein if said privilege response is said approval said privilege response comprises one or more true elevated privileges.

11. The method of claim 9, further comprising the steps:
identifying, responsive to determining that execution of said second application requires said elevated privilege, one or more attributes of said second application;
wherein said request for said elevated privilege is further based on said one or more attributes of said second application.

12. The method of claim 11, wherein said client device comprises a security agent;
wherein said security agent comprises: (a) an agent management module; (b) an agent rules database that stores said at least one privilege rule; (c) an agent communication module that (i) receives said privilege response and (ii) communicates said request for said elevated privilege to said security system; and (d) an agent authentication module that authenticates a source of said privilege response; and (e) an agent encrypt/decrypt module that decrypts said privilege response and that encrypts said request for said elevated privilege.

13. The method of claim 12, wherein said at least one privilege rule is generated by said agent management module or is retrieved from said security system.

14. A computer-implemented method for true privilege application elevation, the steps comprising:
providing security system;
generating and storing, by said security system, one or more device records;
generating and storing, by said security system, one or more security system privilege rules;
receiving a request for an elevated privilege, by said security system;
determining, by said security system, whether to approve or deny said request for said elevated privilege;
generating, by said security system a privilege response;
wherein said privilege response is a response selected from the group of responses selected from: an approval and a denial;
communicating, by said security system, said privilege response to a client device;
wherein if said privilege response is said approval, then an application is executed with said elevated privilege.

15. The method of claim 14, wherein said security system approves or denies said request for said elevated privilege based on said one or more security system privilege rules.

16. The method of claim 15, wherein said security system approves or denies said request for said elevated privilege based on one or more attributes of said application.

17. The method of claim 16, wherein said security system comprises: (a) a security system management module; (b) a security system rules database that stores said one or more security system privilege rules; (c) a security system communication module that (i) receives said request for said elevated privilege and (ii) communicates said response to said request for said elevated privilege to said client device; (d) a security system authentication module that authenticates a source of said request for said elevated privilege; and (e) a security system encrypt/decrypt module that decrypts said request for said elevated privilege and that encrypts said response to said request for said elevated privilege.

18. The method of claim 17, wherein said one or more security system privilege rules are generated by said security system management module.

19. The method of claim 18, wherein if said privilege response is said approval, said privilege response comprises one or more true elevated privileges.

20. The method of claim 19, wherein said security system further comprises: a security system privilege module that retrieves said one or more true elevated privileges.
